(19) United States
(12) Patent Application Publication
(10) Pub. No.: US 2016/0252667 A1
(43) Pub. Date: Sep. 1, 2016

(54) BACKLIGHT UNIT AND DISPLAY DEVICE

(71) Applicant: BOE Technology Group Co., Ltd., Beijing (CN)

(72) Inventors: Lin ZHU, Beijing (CN); Wenbo LI, Beijing (CN)

(21) Appl. No.: 14/768,584

(22) PCT Filed: Mar. 20, 2015
(86) PCT No.: PCT/CN2015/074667

§ 371 Date: Aug. 18, 2015

(30) Foreign Application Priority Data
Oct. 13, 2014 (CN) 201410539438.7

(51) Int. Cl. F21V 8/00

(52) U.S. Cl. CPC G02B 6/003

(57) ABSTRACT

A backlight module and a display device. The backlight unit includes a light guide plate, a light emitting diode located at a light incident side of the light guide plate, and an optical lens disposed between a light emergent side of the light emitting diode and the light incident side of the light guide plate; a first surface of the optical lens close to the light emitting diode has the shape of sawtooth. The backlight unit can increase the light extraction efficiency and reduce heat generation of the backlight unit.

### TECHNICAL FIELD

Embodiments of the present invention relate to a backlight unit and a display device.

### BACKGROUND

A liquid crystal display (LCD) is a kind of passive light emitting device, and a backlight unit (BLU) is required to provide the liquid crystal display with a light source, so as to enable it to display images. Currently, backlight source technologies mainly used in liquid crystal displays include cold cathode fluorescent lamp (CCFL) and light emitting diode (LED). Because LED backlight sources have a variety of advantages such as high brightness, high color purity, long lifetime, good reliability, no mercury pollution, and so on, they take an increasingly growing proportion in the use of backlight sources.

### SUMMARY

According to embodiments of the present invention, there are provided a backlight unit and a display device, with which, such an issue that a backlight unit has a higher thermal energy owing to a low light extraction efficiency of the backlight unit can be solved.

According to at least an embodiment of the present invention, there is provided a backlight unit, which includes a light guide plate, a light emitting diode located at a light incident side of the light guide plate, and an optical lens disposed between a light emergent side of the light emitting diode and the light incident side of the light guide plate; a first surface of the optical lens close to the light emitting diode has the shape of sawtooth.

For example, the optical lens and the light guide plate have an integral structure.

For example, a second surface of the optical lens far away from the light emitting diode is attached to a surface of the light guide plate at a light incident side.

For example, the second surface has a plate shape.

For example, the optical lens is disposed at a surface of the light emitting diode, and configured for encapsulating the light emitting diode.

The sectional shape of sawtooth of the first surface includes at least one of a triangle, a rectangle and a trapezoid.

For example, if the light-emitting angle of the light emitting diode is 120°, the sectional shape of sawtooth of the first surface is each an isosceles triangle; for example, the angular range of a vertex of the isosceles triangle includes 70° to 100°.

For example, material constituting the optical lens includes at least one of polymethyl methacrylate, polyvinyl chloride, polyethylene, polycarbonate and polypropylene.

According to at least an embodiment of the present invention, there is provided a display device, which includes any of the aforesaid backlight units.

### BRIEF DESCRIPTION OF THE DRAWINGS

In order to illustrate the technical solution of the embodiments of the invention more clearly, the drawings of the embodiments will be briefly described below; it is obvious that the drawings as described below are only related to some embodiments of the invention, but are not limitative of the invention.

FIG. la is a structurally schematic view illustrating a display device;

FIG. lb is a schematic view illustrating the partial structure of a backlight unit;

FIG. 2a is a schematic view illustrating the partial structure of a backlight unit provided by an embodiment of the invention;

FIG. 2b is a schematic diagram illustrating the light path transmission of a backlight unit provided by an embodiment of the invention;

FIG. 3a to FIG. 3c are schematic views illustrating multiple setting modes of optical lens provided by an embodiment of the invention;

FIG. 4a to FIG. 4c are structurally schematic views illustrating diversified optical lenses provided by an embodiment of the invention; and

FIG. 5 is a schematic diagram illustrating the light path transmission of another backlight unit provided by an embodiment of the invention.

### REFERENCE NUMERALS

10—color filter substrate; 11—array substrate; 12—liquid crystal layer; 13—light guide plate; 131—dot; 14—light source; 141—light emitting diode; 15—reflecting plate; 20—optical lens; A—first surface of the optical lens; B- second surface of the optical lens; C—side face of sawtooth on the first surface; D—another surface of sawtooth adjacent to the sawtooth on the first surface; e—light beam emitted by the light emitting diode; α—light-emitting angle of the light emitting diode; β—vertex of an isosceles triangle-shaped cross section of a sawtooth

### DETAILED DESCRIPTION

In order to make objects, technical details and advantages of the embodiments of the invention apparent, hereinafter, the technical solutions of the embodiments of the invention will be described in a clearly and fully understandable way in connection with the drawings related to the embodiments of the invention. It is obvious that the described embodiments are just a part but not all of the embodiments of the invention. Based on the described embodiments of the invention, those ordinarily skilled in the art can obtain other embodiment(s), without any inventive work, which should be within the scope sought for protection by the invention.

In liquid crystal displays, LED backlight sources can be classified into a direct-light type and a side-light type. A structure of a side-light type is shown in FIG. 1a. A display panel includes a color filter substrate 10 and an array substrate 11 that are disposed to be cell-aligned with each other, and a liquid crystal layer 12 is provided between the color filter substrate 10 and the array substrate 11. A backlight unit under the display panel includes a light guide plate 13 with dots provided thereon, a light source 14 located at a side of the light guide plate 13, and a reflecting plate 15 located at the rear side of the light guide plate 13. After light emitted by the light source 14 is incident into the light guide plate 13, it is propagated toward a light emergent side of the display panel after it is reflected by the reflecting plate 15 and scattered by the dots 131, so as to achieve a purpose of providing the liquid crystal display with a light source for allowing it to display images.

However, in the above backlight unit structure, during the propagation of the light emitted by a single light emitting diode 141 on the light source 14 onto the light guide plate 13, loss of light will occur. For example, as shown in FIG. 1b, when light is irradiated onto a surface of the light guide plate 13 at a light incident side, a part of the incident light (denoted by dotted-lines in the figure) will be reflected by the surface, so that the part of light cannot be incident into the light guide plate. This leads to loss of light, and reduces the light extraction efficiency of the backlight unit. Thus, the display effect of the display is affected disadvantageously.

In order to solve the above problem, generally the number of light emitting diodes 141 may be increased. However, this method will cause the backlight unit to generate too much heat. If the heat cannot be effectively released, it will bring about an adverse influence on an internal structure of the display, such as, the liquid crystal layer, the thin film layer constituted by a resin material or a metallic material. Consequently, the product quality is degraded.

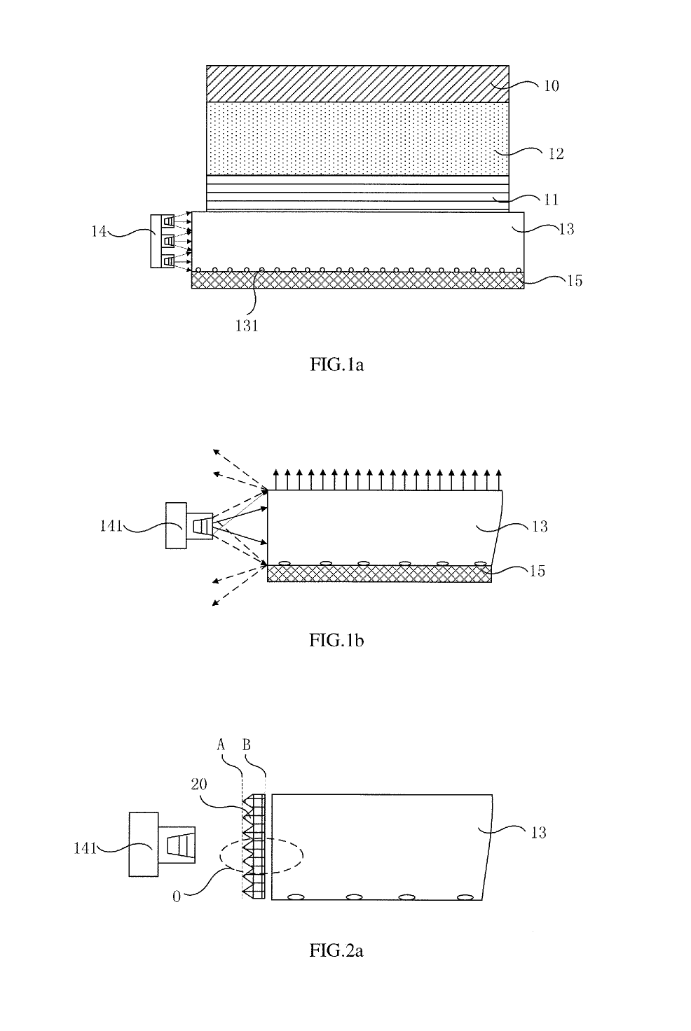

According to at least an embodiment of the invention, there is provided a backlight unit, as shown in FIG. 2a, which may include a light guide plate 13 and a light emitting diode 141 located at a light incident side of the light guide plate 13. As shown in FIG. 2a, the backlight unit may further include an optical lens 20 provided between a light emergent side of the light emitting diode 141 and the light incident side of the light guide plate 13.

For example, a first surface A of the optical lens 20 close to the light emitting diode 141 has the shape of sawtooth.

Specifically, the light propagation path of the optical lens 20 is shown by an enlarged diagram (FIG. 2b) at the location of ‘O’. As can be seen, after a beam of light e that is emitted by the light emitting diode 141 is irradiated onto a side face C of a sawtooth of the first surface A of the optical lens 20, it is reflected at the surface C; the reflected light will be irradiated onto a sawtooth adjacent to the above sawtooth, and reflected at another side face D of the adjacent sawtooth after being refracted; and the light after reflection is incident into the light guide plate. Therefore, the contact face with the outgoing light of the light emitting diode can be increased by the first surface in a zigzag shape. The above contact face can serve to change the propagation path of light, so that light originally incapable of being incident into the light guide plate is eventually incident into the light guide plate after it is reflected and refracted multiple times. Thus, the utilization ratio of light emitted by the light emitting diode is enhanced.

According to at least an embodiment of the invention, there is provided a backlight unit, which includes a light guide plate and a light emitting diode located at a light incident side of the light guide plate. Light emitted by the light emitting diode enters a display panel after it is conducted and scattered by the light guide plate, and is emitted out from a light emergent side of the display panel. The backlight unit further includes an optical lens disposed between the light emergent side of the light emitting diode and the light incident side of the light guide plate; and a first surface of the optical lens close to the light emitting diode has the shape of sawtooth. The sawtooth-shaped first surface can serve to increase the contact area between it and light emitted by the light emitting diode, so that light incident from a side face of a sawtooth and reflected can enter a sawtooth adjacent to it, and go into the light guide plate by reflection from another side face of the adjacent sawtooth after it is refracted. As a result, according to embodiments of the invention, loss of the reflected light can be reduced, and this enables more light to be incident to the light guide plate. Thus, the light extraction efficiency of the backlight unit is enhanced.

Moreover, because the utilization ratio of light of each light emitting diode is increased, the amount of light emitting diodes required by the backlight unit can be decreased without affecting the display effect. Thus, the power consumption can be reduced. This also avoids an adverse effect of too much heat generated by the backlight unit on the display panel. In turn, the product quality can be improved.

The setting mode of the above-mentioned optical lens 20 will be described below by example.

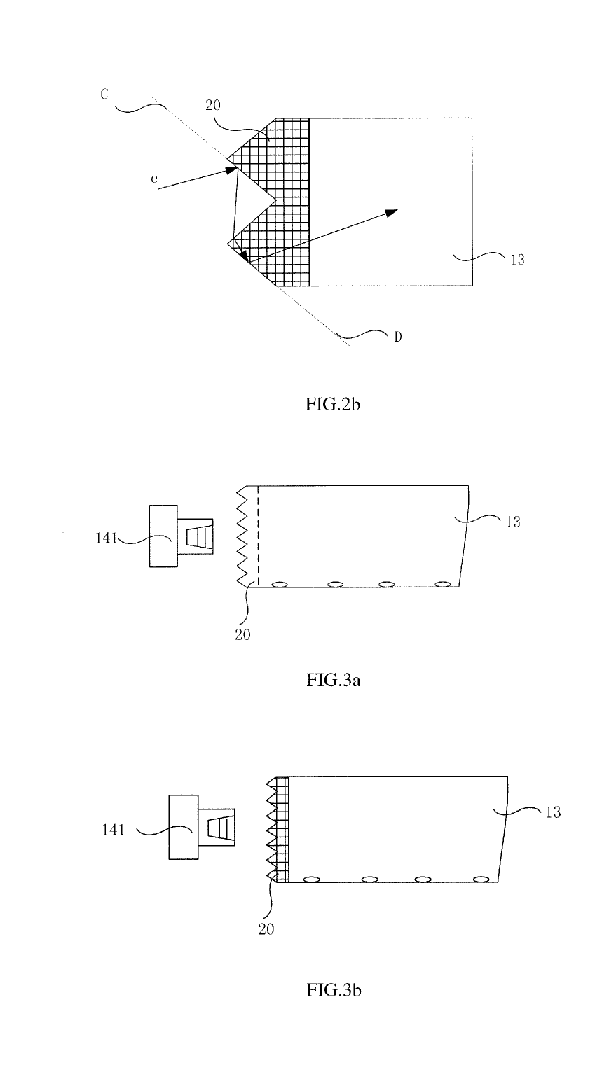

As shown in FIG. 3a, an optical lens 20 and the above light guide plate 13 may be configured to be an integral structure. In this way, in the course of manufacturing the light guide plate 13, the manufacture of the optical lens 20 can just be conducted, thereby enhancing the production efficiency. The light guide plate 13 can be made of glass or a transparent resin material.

As shown in FIG. 3b, it is possible that for an optical lens 20 fabricated in a separate production process, its second surface B that lies far away from the light emitting diode 141 is attached to a surface of the light guide plate 13 at a light incident side.

On this basis, in order to improve the attaching fitting degree between the optical lens 20 and the light guide plate 13, for example, the second surface B of the above optical lens 20 is configured to be in a plate shape.

In the above scheme, the optical lens 20 and the light guide plate 13 can be made in separate fabricating processes. In this way, the optical lens 20 can be integrated onto the light guide plate 13. Therefore, the producing difficulty of the light guide plate 13 will not be increased. Because a separate production process is used for the optical lens 20, it is in favor of enhancing precision of the product.

As shown in FIG. 3c, it is also possible that an optical lens 20 is disposed on a surface of a light emitting diode 141, and used to encapsulate the light emitting diode 141, so that the light emitting diode 141 is arranged in the optical lens. In this way, light emitted by the light emitting diode 141 can be fully irradiated onto a first surface A of the optical lens 20. Under the action of the sawtooth-shaped first surface A, the propagation path of light emitted by the light emitting diode 141 can be changed, so as to produce a converging effect. This enables more light to be incident into the light guide plate 13. Thus, the utilization ratio of light is increased.

Certainly, the forgoing are merely exemplary illustrations of setting mode of the optical lens 20, and other modes will not be given by example one by one any longer, but they shall all belong to the protection scope of the present invention.

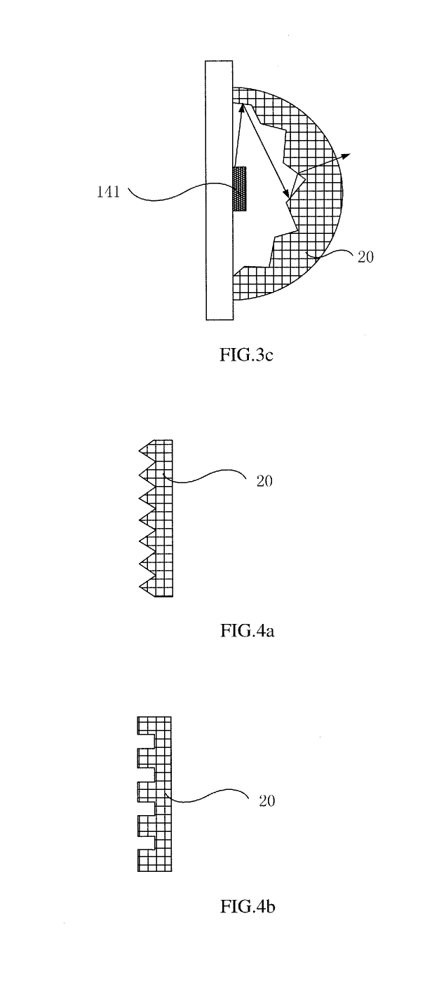

It is to be noted that, firstly, the present invention does not set a limit to the sectional shape of sawteeth of the first surface A. The sectional shape of the sawteeth may be a regular pattern, and may also be an irregular pattern. In order to simplify the production process, it is designed to be a regular pattern. For example, it may be a triangle as shown in FIG. 4a, or a rectangle as shown in FIG. 4b, or otherwise, it may also be at least one of trapezoids as shown in FIG. 4c.

Secondly, the present invention does limit the distance between the top and bottom of a sawtooth in the sawtooth-shaped first surface A. For example, in order to change the propagation path of more light, the distance between the top and bottom can be increased. Then, the area of an inclined plane of a sawtooth can be increased, so as to receive more light, and change the propagation path of them.

Thirdly, the shapes of sawteeth in the sawtooth-shaped first surface A may be uniform in one shape, and may also be in different shapes.

Fourthly, if the shapes of sawteeth in the sawtooth-shaped first surface A is uniform in one shape, the present invention does not set a limit to the size of each sawtooth. That is, size of each sawtooth may be equal, and may also not be equal.

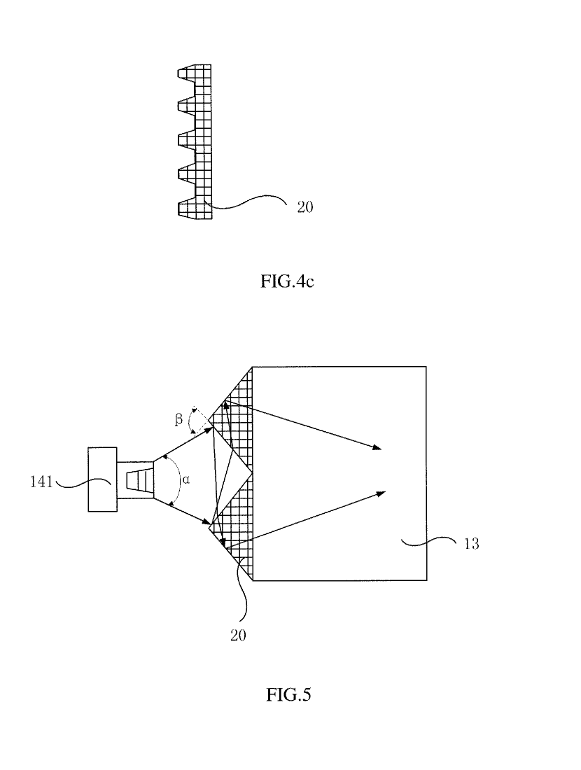

For example, as shown in FIG. 5, if a light-emitting angle a of the light emitting diode 141 is 120 degrees, the sectional shape of sawtooth of the first surface A is each an isosceles triangle; and the angular range of a vertex β of the isosceles triangle may include 70° to 100°. In this way, each sawtooth of the optical lens 20 may be an isosceles triangular column. Owing to the uniform sawtooth structure, such an optical lens 20 is in favor of processing and precision control. If locations of the light emitting diode 141 and the light guide plate 13 are arranged with a conventional distance, all light within the light-emitting angle α can be converged by the first surface A with the sawteeth structure to the maximum extent, and will be eventually irradiated into the light guide plate. Thus, the light extraction efficiency of the backlight unit is greatly enhanced, and the power consumption is reduced.

Fifth, when a resin material is used for producing the optical lens 20, the material constituting the optical lens 20 may include certain material having a higher light transmission, such as, at least one of polymethyl methacrylate (PMMA), polyvinyl chloride (PVC), polyethylene (PE), polycarbonate (PC) and polypropylene (PP).

According to at least an embodiment of the present invention, there is provided a display device, which includes any of the above-mentioned backlight units with the same structure and beneficial effects as the backlight unit in foregoing embodiments. As the structure and beneficial effects of the backlight unit have already been described in foregoing embodiments, details are omitted here.

It is to be noted that, in at least an embodiment of the present invention, the display device may specifically include a liquid crystal display device. For example, the display device may be a liquid crystal display, a liquid crystal television, a digital photo frame, a cell phone, a tablet computer or any other product or component having a display function.

The descriptions made above are merely exemplary embodiments of the invention, but are not used to limit the protection scope of the invention. The protection scope of the invention is determined by attached claims.

This application claims the benefit of priority from Chinese patent application No. 201410539438.7, filed on Oct. 13, 2014, the disclosure of which is incorporated herein in its entirety by reference as a part of the present application.

1. A backlight unit, comprising a light guide plate, a light emitting diode located at a light incident side of the light guide plate, and an optical lens disposed between a light emergent side of the light emitting diode and the light incident side of the light guide plate;
wherein a first surface of the optical lens close to the light emitting diode has the shape of sawtooth.

2. The backlight unit claimed as claim 1, wherein the optical lens and the light guide plate have an integral structure.

3. The backlight unit claimed as claim 1, wherein a second surface of the optical lens far away from the light emitting diode is attached to a surface of the light guide plate at a light incident side.

4. The backlight unit claimed as claim 3, wherein the second surface has a plate shape.

5. The backlight unit claimed as claim 1, wherein the optical lens is disposed at a surface of the light emitting diode, and configured for encapsulating the light emitting diode.

6. The backlight unit claimed as claim 1, wherein the sectional shape of the sawtooth of the first surface includes at least one of a triangle, a rectangle and a trapezoid.

7. The backlight unit claimed as claim 6, wherein if the light-emitting angle of the light emitting diode is 120°, the sectional shape of sawtooth of the first surface is each an isosceles triangle; and the angular range of a vertex of the isosceles triangle includes 70° to 100°.

8. The backlight unit claimed as claim 3, wherein a material constituting the optical lens includes at least one of polymethyl methacrylate, polyvinyl chloride, polyethylene, polycarbonate and polypropylene.

9. A display device, comprising the backlight unit claimed as claim 1.

10. The backlight unit claimed as claim 5, wherein a material constituting the optical lens includes at least one of polymethyl methacrylate, polyvinyl chloride, polyethylene, polycarbonate and polypropylene.

11. The backlight unit claimed as claim 2, wherein the sectional shape of the sawtooth of the first surface includes at least one of a triangle, a rectangle and a trapezoid.

12. The backlight unit claimed as claim 11, wherein if the light-emitting angle of the light emitting diode is 120°, the sectional shape of sawtooth of the first surface is each an isosceles triangle; and the angular range of a vertex of the isosceles triangle includes 70° to 100°.

13. The backlight unit claimed as claim 3, wherein the sectional shape of the sawtooth of the first surface includes at least one of a triangle, a rectangle and a trapezoid.

14. The backlight unit claimed as claim 13, wherein if the light-emitting angle of the light emitting diode is 120°, the sectional shape of sawtooth of the first surface is each an isosceles triangle; and the angular range of a vertex of the isosceles triangle includes 70° to 100°.

15. The backlight unit claimed as claim 5, wherein the sectional shape of the sawtooth of the first surface includes at least one of a triangle, a rectangle and a trapezoid.

16. The backlight unit claimed as claim 15, wherein if the light-emitting angle of the light emitting diode is 120°, the sectional shape of sawtooth of the first surface is each an isosceles triangle; and the angular range of a vertex of the isosceles triangle includes 70° to 100°.
